(19) United States
(12) Patent Application Publication
(10) Pub. No.: US 2025/0173594 A1
(43) Pub. Date: May 29, 2025

(54) ENHANCING OPITCAL NONLINEARITY THROUGH XPM TEMPORAL TRAPPING

(71) Applicant: NTT RESEARCH, INC., Sunnyvale, CA (US)

(72) Inventors: Ryan HAMERLY, Sunnyvale, CA (US); Ryotatsu YANAGIMOTO, Sunnyvale, CA (US); Marc JANKOWSKI, Sunnyvale, CA (US); Edwin NG, Sunnyvale, CA (US)

(73) Assignees: NTT RESEARCH, INC., Sunnyvale, CA (US); MASSACHUSETTS INSTITUE OF TECHNOLOGY, Cambridge, MA (US); THE BOARD OF TRUSTEES OF THE LELAND STANFORD JUNIOR UNIVERSITY, Stanford, CA (US)

(21) Appl. No.: 18/844,687

(22) PCT Filed: Mar. 13, 2023
(86) PCT No.: PCT/US2023/064254

§ 371 Date: Sep. 6, 2024

Related U.S. Application Data
(60) Provisional application No. 63/319,680, filed on Mar. 14, 2022.

(51) Int. Cl. G06N 10/40; G02F 1/365

(52) U.S. Cl. CPC G06N 10/40; G02F 1/365

(57) ABSTRACT

Systems and methods for confining an optical signal in a non-linear optical quantum computing system are disclosed. An optical signal and a trap field are provided in the non-linear optical quantum computing system. The trap field propagates with and confines the optical signal in time and/or space. The non-linear optical quantum computing system may be structured as a ring, a single-pass waveguide or a segmented single-pass waveguide. In some cases, multiple optical signals may be input into the system and evaluated in a multiplexed fashion.

### PRIORITY

This application claims priority to U.S. Provisional Application No. 63/319,680, filed Mar. 14, 2022 and entitled “Enhancing Optical Nonlinearity Through XPM Temporal Trapping,” which has been hereby incorporate in its entirety by reference.

### FIELD

The disclosure relates to systems and methods for enhancing optical nonlinearity. In particular, the disclosure relates to systems and methods for enhancing optical nonlinearity by using one or more of cross-phase modulation temporal trapping.

### BACKGROUND

Optical quantum computing (OQC) involves the use of optical (photonic) systems to perform computing operations. For example, FIG. 1A depicts a model of dual-rail qubit encoding, according to some embodiments. As shown, qubits are usually encoded on a dual-rail basis based on a state occupied by a photon. These states can be based on space, time, frequency, or the like. This dual-rail basis has inherent advantages, such as making the states insensitive to errors resulting from timing or frequency shifts. In addition, single-photon gates can be easily implemented with the use of linear optics. For example, FIG. 1B depicts illustrative single-photon gates implemented in an OQC system, according to some embodiments. As shown, X and Z gates have been implemented by using linear optics.

However, other gates within an OQC system are more difficult to realize. For instance, an entangling gate is significantly more difficult to realize than a single-photon gate. For example, FIG. 1C depicts an illustration of a controlled-Z (CZ) gate implemented using Hong-Ou-Mandel (HOM) interference and Kerr phase gates in an OGC system, according to some embodiments. In this shown example, the CZ gate can be realized using a HOM interference and a Kerr phase gate that performs the operation:

$${\hat{U}}_{π} [ a \vert 0 〉 + b \vert 1 〉 + c \vert 2 〉 ] = a \vert 0 〉 + b \vert 1 〉 - c \vert 2 〉 .$$

In particular, the Kerr gate is the most difficult-to-realize part of any current OQC system because of the weak (perturbative) nature of optical nonlinearity.

OQC systems are bifurcated into two camps depending upon how the Kerr gate is realized: linear OQC and non-linear OQC. For example, FIG. 1D depicts an illustrative implementation of a Kerr gate in a linear OQC system and alternative systems that may be used for nonlinear optical quantum computing, according to some embodiments. Under linear OQC (LOQC), as shown, the Kerr gate is implemented using single-photon sources, detectors and linear optics. While currently feasible to produce, such gates are probabilistic with an upper bound p<3/4, and the best known system giving p=2/27. Two approaches have currently been developed to deal with probabilistic gates: (1) the KLM approach, which improves gate probability with conditional preparation of entangled ancilla states, and (2) the cluster-state approach, which focuses on building up large cluster states with CZ operations. However, these approaches incur a substantial amount of overhead in encoding required ancillae/clusters.

In contrast, non-linear OQC (NLOQC) systems implement gates deterministically using nonlinear optics. Nonlinear optics (NLO) involves the use of photon-photon interactions, which usually produce a particularly weak response, so increasing the strength by optimizing various parameters of the interaction is a particularly desirable goal. While NLOQC systems avoid the overhead of distilling ancillae/cluster states, a single photon Kerr gate Û_{π}, has been exceptionally difficult to realize. Within NLOQC, three NLO effects have been significantly investigated: cavity QED (cQED), χ⁽²⁾ (parametric), and χ⁽³⁾ (Kerr). cQED produces the strongest effect and is the only one of the three that has achieved a single-photon NLO to date. However, cQED systems only operate at cryogenic temperatures or in a vacuum making them infeasible for general use. In addition, such systems have proved challenging in terms of fabrication, yield and noise even after decades of research. Bulk nonlinearities such as χ⁽²⁾ and χ⁽³⁾ are significantly easier to work with, but also produce much weaker responses. As such, low loss and tight conferment are needed to harness these nonlinearities. FIG. 1D further depicts illustrative systems that have been shown to reduce loss and provide tight confinement for Kerr gates as NLOQC systems: photonic crystal (PhC) cavities, microring resonators (MRR) and a pulse in a dispersion-engineered waveguide.

While the above discussion focused on quantum gates based on a dual-rail encoding, the contrast between LOQC and NLOQC are more general. Specifically, quantum operations can either be constructed using photodetection and heralding (LOQC) or deterministically through a nonlinear interaction (NLOQC). As another example, in the continuous variable framework of Gottesman-Kitaev-Preskill (GKP) states, the central challenge is to construct the GKP and cubic-phase states, which are resource states in a computational protocol. These states can either be constructed using heralded linear circuits (LOQC) or deterministically through a coherent nonlinear interaction (NLOQC).

As a result, NLOQC systems have sought either to increase the photon interaction time or to confine photons spatially to better detect the interaction. Over the last half century or so, systems using these techniques have increased the interaction strength by a factor of 10⁶. However, further improvement is required to reach a single-photon regime and enable nonlinear-optical quantum computing.

It is desirable to provide a NLOQC system that provides enhanced photon interaction strength and with reduced mode volumes as compared with traditional techniques, and it is to this end that this disclosure is directed.

### SUMMARY

Systems and methods may be used for non-linear optical quantum computing that uses a temporal confinement technique configured to confine light using a nonlinear interaction between a target field and a trap field.

In an embodiment, a method for confining an optical signal in a non-linear optical quantum computing system comprises generating an optical signal in the non-linear optical quantum computing system and generating a trap field configured to confine the optical signal by causing a nonlinear interaction, wherein the trap field propagates with the optical signal.

In another embodiment, non-linear optical quantum computing system configured to generate an optical signal and generate a trap field that confines the optical signal by causing a nonlinear interaction, wherein the trap field propagates with the optical signal.

### BRIEF DESCRIPTION OF THE DRAWINGS

FIG. 1A depicts a model of dual-rail qubit encoding, according to some embodiments.

FIG. 1B depicts illustrative single-photon gates implemented in an optical quantum computing system, according to some embodiments.

FIG. 1C depicts an illustration of a CZ gate implemented using HOM and Kerr phase gates in an optical quantum computing system, according to some embodiments.

FIG. 1D depicts an illustrative implementation of a Kerr gate in a linear optical quantum computing system and alternative systems that may be used for nonlinear optical quantum computing, according to some embodiments.

FIG. 2A depicts a temporal trapping mechanism configured to confine an optical signal in a non-linear optical quantum computing system, according to some embodiments.

FIG. 2B depicts optical signals without a temporal trap, according to some embodiments.

FIG. 2C depicts optical signals subject to a temporal trap in which the bound state is separated from continuum modes by an energy gap, according to some embodiments.

FIG. 3A depicts an illustration of a target field confined in a temporal trap, according to some embodiments.

FIG. 3B depicts an illustration of a target field confined in a spatial trap, according to some embodiments.

FIG. 3C depicts an illustration of a target field confined in a temporal and spatial trap, according to some embodiments.

FIG. 4A depicts a ring structure for a non-linear optical quantum computing system configured to confine an optical signal, according to some embodiments.

FIG. 4B depicts a single-pass waveguide structure for a non-linear optical quantum computing system configured to confine an optical signal, according to some embodiments.

FIG. 4C depicts a segmented single-pass waveguide structure for a non-linear optical quantum computing system configured to confine an optical signal, according to some embodiments.

FIG. 5A depicts an instantaneous method of loading and unloading trapped pulses from an optical cavity using a fast switch, according to some embodiments.

FIG. 5B depicts a gradual method of loading and unloading trapped pulses from an optical cavity using a slow switch, according to some embodiments.

FIG. 5C depicts loading and unloading trapped pulses in a manner that forms a grid-state temporal dual-rail qubit, according to some embodiments.

FIG. 6A depicts an illustrative non-multiplexed solution for implementing a CZ gate, according to some embodiments.

FIG. 6B depicts an illustrative multiplexed solution for implementing a CZ gate, according to some embodiments.

FIG. 7A depicts illustrative quantum computing gates that can be implemented with intracavity pulses using trap-potential engineering, according to some embodiments.

FIG. 7B depicts linear-optical transformations corresponding to the illustrative quantum computing gates of FIG. 7A, according to some embodiments.

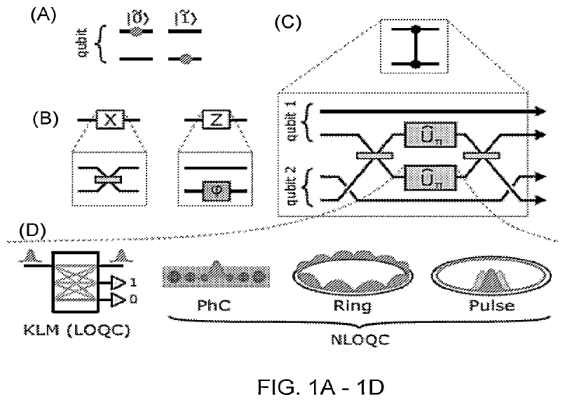

### DETAILED DESCRIPTION

Embodiments disclosed herein describe temporally confining an optical signal (e.g., a photon). For example, a trap pulse may be generated to co-propagate with the optical signal, wherein the trap pulse uses cross phase modulation (XPM) to create a dynamic/flying photonic cavity confining the optical signal. In other words, the trap pulse propagates with the optical signal. These embodiments may then generally increase the interaction strength between the trap pulse and the optical signal by orders of magnitude compared to existing systems, thereby providing significant improvement in photonic platforms such as thin-film Lithium Niobate to implement non-linear OQCs. Furthermore, time multiplexing may be performed to generate multiple identical qubits from a single resonator to enable highly parallel computation, cluster-state generation, and quantum simulation.

Optical nonlinearity may be enhanced through a variety of factors that provide a combination of phase matching and confinement. Birefringent phase matching, quasi-phase matching, waveguiding, loss reduction, resonance, and dispersion engineering are illustrative techniques that are used to enhance optical nonlinearity and approach the strong-coupling limit. Strong coupling occurs when the nonlinear Hamiltonian is large enough to shift the energy levels by more than a linewidth, thereby producing strongly anharmonic oscillators that behave like qubits. Alternatively, strong coupling can be said to occur when a system simultaneously realizes a strong optical quality factor, Q, and a small mode volume, V, in a medium with high material nonlinearity. Although the above-listed advances have led to strong coupling in cQED systems, NLOQC has not been realized with cQED due to fabrication and scaling difficulties. In contrast, bulk nonlinearities like χ⁽³⁾ and χ⁽²⁾ are more robust and scalable, but are also weaker than cQED and require greater geometric enhancement. For nonlinear optical computing Hamiltonians (H_{NL})

$${H}_{NL} = \{ \begin{matrix}\frac{1}{2} ε ( {a}^{2} {b}^{†} + {( {a}^{†} )}^{2} b ) & {χ}^{( 2 )} / SHG \\ \frac{1}{4} χ {a}^{†} {a}^{†} aa & {χ}^{( 3 )} / Kerr\end{matrix}$$

strong coupling is defined by the cooperativity, C, given by the following formulas for χ⁽²⁾ and χ⁽³⁾, respectively:

$$C = \{ \begin{matrix}\frac{ε}{\sqrt{{κ}_{a} {κ}_{b}}} = \sqrt{\frac{4 π ℏ {cd}_{eff}^{2}}{{n}^{3} {ε}_{0} {λ}^{4}} \frac{{Q}_{ω} {Q}_{2 ω}}{{\check{V}}_{sh}}} & {χ}^{( 2 )} \\ \frac{χ}{κ} = \frac{3 πℏ {cn}^{3} {χ}^{( 3 )}}{2 {πε}_{0} {λ}_{4}} \frac{{Q}_{ω}}{{\check{V}}_{k}} & {χ}^{( 3 )}\end{matrix}$$

where λ is the drive wavelength, d_{eff} and χ⁽³⁾ are nonlinear coefficients, and V̌=V/(λ/n)³ is the normalized volume. The cooperativity for two common low-loss optical materials is shown in Table 1 at λ=1.55 μm.

TABLE 1
Comparison of χ⁽²⁾ and χ⁽³⁾ cooperatively using LiNbO₃
(d_{eff} = 33 pm/V, n = 2.2) and Si (χ⁽³⁾ = 0.3 nm²/
V², n = 3.5) at λ = 1.55 μm.

| NLO | Material | C |
|---|---|---|
| χ⁽²⁾ | LiNbO₃ | (1 × 10⁻⁶)(Q_{ω}Q_{2ω}/V̌ₛₕ)^{1/2} |
| χ⁽³⁾ | Si | (2 × 10⁻¹⁰)Q_{ω}/V̌ₖ |

Assuming that V̌_{TPA}≅V̌_{Kerr}=V̌, the ratio of these coefficients is:

$$\frac{{C}_{{χ}^{( 2 )}}}{{C}_{{χ}^{( 3 )}}} = 3500 \sqrt{( {Q}_{2 ω} / {Q}_{ω} ) V} .$$

The large prefactor in the above equation illustrates that the χ⁽²⁾ effect is significantly stronger than the χ⁽³⁾ effect provided that both harmonics resonate at high Q. This advantage increases even more if the cavity mode volume increases because C decreases more quickly with V for the Kerr case.

As mentioned above, competing approaches for NLOQC systems may include photonic crystal cavities, microring resonators, or short optical pulses in a dispersed-engineered waveguide. An analysis of each with respect to temporal traps using cross-phase modulation is presented below.

For photonic crystal cavities, two-dimensional photonic crystals may be used to confine light to V̌<1 with Q>10⁶, where Q is an optical quality factor. Although the value of Q for a photonic crystal is theoretically unlimited provided that all multipole orders are cancelled, such as in adiabatic designs in nanobeams or line-defect cavities or with numerical optimization for point-defect cavities, it has proven difficult to achieve an optical quality factor above 10⁷ because of surface roughness and absorption. Even achieving an optical quality factor approaching 10⁷ is only possible with low device yields. A more commonly achieved Q value is closer to 10⁶. Moreover, in crystals having such high Q values, the cavities are very sensitive to thermorefractive noise, which limits achievable Q values at room temperature. In addition, photonic crystal band gaps do not span an octave. As such, it is difficult to simultaneously resonate a field and its second harmonic at high Q values. Indeed, although many doubly-resonant photonic crystals have been proposed, such crystals all have relatively low Q_{2ω} values (Q_{2ω}<10⁴). This limits the prospects for a viable χ⁽²⁾ process.

Dielectric bowtie “tip” structures have been shown to achieve deep-subwavelength confinement without compromising the optical quality values. Tip structure design can be understood in terms of the competing Maxwell boundary conditions in slot/bridge structures or the field divergences at dielectric corners. Because the tip is dielectric, it does not incur losses of plasmonic bowtie cavities. In addition, because the top is a subwavelength feature, it does not scatter light to the far field. Rather, although the optical energy remains distributed over a volume that is much larger than the tip itself, the field divergence may cause the quantities V_{cQED}⁻¹∝|Eₘₐₓ|², Vₖ⁻¹∝∫|E|⁴ dV, and Vₛₕ^{-1/2}∝∫|E|³dV to diverge, thereby leading to deep-subwavelength effective node volumes.

Ring resonators can achieve high Q values if volume is not a critical consideration. Unlike photonic crystals, rings are guided by total internal reflection, which is not wavelength-sensitive. As such, ring resonators tend to have higher Q values, limited primarily by waveguide losses. Moreover, such resonances can easily span an octave. For example, losses of 3 dB/m (Q=10⁷) have been achieved using smart-cut LiNbO₃. Lower losses are possible with better manufacturing processes and materials. For example, a Chemical Mechanical Polishing (CMP)-based process has achieved losses down to 0.3 dB/m (Q=10⁸), which is close to the bulk material limit. In addition, rings are convenient systems with which to work because of their simple design, because rings can tolerate shallower etch angles, and because rings support both quasi-phase matching and dispersion engineering.

A downside to using ring resonators is the large mode volume (V≳100), which is necessary to ensure efficient total internal reflection and to reduce surface-roughness scattering. It is also more straightforward to tune larger rings due to narrower mode spacing, and to avoid the challenges of resonant backscattering of light that become acute for small ring radii.

Strong photon-photon coupling can be realized by confining photons temporally using short optical pulses in a waveguide. Although such a pulse quickly spreads apart, the waveguides may be engineered to eliminate leading-order dispersion terms, such as group-velocity mismatch (GVM) and group-velocity dispersion (GVD). Such “dispersion-engineered” waveguides may allow short pulses to propagate much longer distances than otherwise possible. This may result in novel “quasi-static” (dispersion-free) non-linear interactions. As such, short optical pulses in a waveguide enable the high optical quality factors of the ring cavities with significantly smaller mode volumes because the pulse width can be much shorter than a ring's repetition rate.

However, optical pulses are sensitive to residual dispersion. For example, a pulse may be required to propagate a distance of z≳1 m without breaking up to make use of the advantage of the high Q value. As a result, tight tolerances for GVM (|Δβ₁|<0.1 fs/mm) and GVD (|β₂|<10 fs²/mm) may be required. Higher-order dispersion also cannot be ignored for such pulse widths and propagation distances. Moreover, non-linear mode distortions may prevent the realization of high-fidelity gates even without any dispersion.

Table 2 summarizes the figures of merit for each platform and provides a calculation of the cooperativity for LiNbO₃ (χ⁽²⁾) and Si (χ⁽³⁾). Based on the values in Table 2, using Si as a material does not lend itself to strong coupling. Similarly, for LiNbO₃, strong coupling is unlikely to be achievable using either photonic crystal cavities or ring resonators, although improvements to ring resonators may make this more feasible in the future. On the other hand, strong coupling is already feasible with short optical pulses if dispersion and distortion can be controlled. Temporal trapping using cross-phase modulation, as disclosed herein, controls dispersion and distortion for short optical pulses and permits strong coupling in NLOQC systems.

TABLE 2
Q, V, and cooperativity for alternate confinement mechanisms,
Si and LiNBO₃, at λ = 1.55 μm.

| | Q_{ω} | Q_{2ω} | \tilde{V}ₖ | V̌ₛₕ | C_{χ}_{⁽²⁾} | C_{χ}_{⁽³⁾} | Modes |
|---|---|---|---|---|---|---|---|
| PhC* | 10⁶ | 10⁴ | 10⁻² | 1 | 0.1 | 0.02 | 1 |
| Ring† | 10⁷ | 10⁷ | 10³ | 10³ | 0.3 | 10⁻⁶ | 1 |
| Pulse‡ | 10⁷ | 10⁷ | 10 | 10 | 3 | 10⁻³ | >>1 |

*Tip-cavity PhC engineered

In some embodiments, a temporal-trapping method based on cross-phase modulation (XPM) may be used to project the dynamics of dispersion-engineered waveguides onto a single pulse basis. In addition to the data pulses, the cavity hosts a trap pulse driven by a strong classical pulse train. XPM between the trap field and the data pulses leads to a time-dependent detuning, which functions as a potential well confining the signals in time. The interplay between temporal trapping and dispersion leads to the emergence of stable pulsed modes, for which solutions are obtained from the bound-state eigenmodes of a Schrödinger equation. Spurious modes are detuned away from resonance as a result of the energy gap between bound and continuum states, thereby projecting the pulsed dynamics loosely onto a single mode target. In other words, XPM time gating enables the NLOQC system to obtain the cooperativity boost of pulsed operation with the relative simplicity of single-mode dynamics.

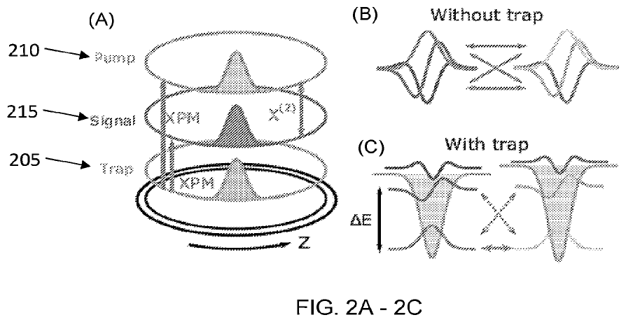

FIG. 2A depicts a temporal trapping mechanism configured to confine an optical signal in a non-linear optical quantum computing system, according to some embodiments. As shown in FIG. 2A, a trap field 205 is an optical pulse that imparts a time-dependent phase shift on the target fields (the pump field 210 and the signal field 215). The dynamics of the target fields are governed by a Schrödinger equation:

$$i \frac{\partial ψ}{\partial t} = {\underbrace{[ - \frac{{β}_{2}}{2 {v}_{g}} \frac{{\partial }^{2}}{\partial {τ}^{2}} + V ( τ ) ] ψ}}_{\hat{H}} + ( NLO )$$

where, t and τ are the “slow” and “fast” times for cavity pulse dynamics, v_{g} and β₂ are the group velocity and GVD, and V(τ) is the trap-induced potential, which is proportional to the trap pulse power for cross-phase modulation. When β₂ has the correct sign (negative for a bright-pulse trap, positive for a dark-pulse trap), Ĥ possesses bound states that are separated from the continuum by a finite energy gap. These bound states are analogous to optical solitons, where nonlinearity compensates for dispersive broadening. In such an embodiment, the non-linearity is induced by the trap field 205 rather than the target field itself. As such, the overall dynamics are linear.

FIG. 2B depicts optical signals without a temporal trap, according to some embodiments. As shown, in a dispersion-engineered cavity without temporal trapping, all modes are degenerate in the comoving frame of reference. As a result, the pulse shape is vulnerable to residual cavity dispersion and mode distortion that arises inexorably from the nonlinearity itself. FIG. 2C depicts optical signals subject to a temporal trap in which the bound state is separated from continuum modes by an energy gap, according to some embodiments. As shown in FIG. 2C and in contrast to the above, in a temporal trap, the bound state is separated from all continuum modes (and higher-order bound states) by an energy gap ΔE. This energy gap detunes away all spurious modes and, as a result, the pulse does not suffer from residual dispersion or nonlinear distortion. The dynamics are projected onto a single-mode subspace, thereby allowing the realization of high-fidelity gates. In this manner, temporal trapping overcomes the tradeoff between interaction strength and gate fidelity that arises in waveguided NLO. In other words, the temporal trap provides strong interactions at high fidelity.

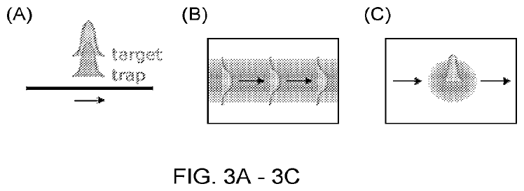

FIG. 3A depicts an illustration of a target field confined in a temporal trap, according to some embodiments. In these embodiments, confinement may be performed in a temporal trap, such as is shown in FIG. 3A.

FIG. 3B depicts an illustration of a target field confined in a spatial trap, according to some embodiments. In these embodiments, confinement may be performed in a spatial-soliton analog of the trap. In these embodiments, a bulk crystal or slab may be used, and the trapping field may create a waveguide that prevents the target field from diffracting.

FIG. 3C depicts an illustration of a target field confined in a temporal and spatial trap, according to some embodiments. In these embodiments, confinement may be performed in a trap that comprises both a temporal trap and a spatial-soliton analog.

In some embodiments, confinement may be facilitated by cross-phase modulation from an optical pulse, such as is shown in FIG. 2A above.

In some embodiments, confinement may be facilitated by Pockels modulation from a radio frequency (RF)/terahertz (THz) pulse. In such embodiments, trapping is mediated by the Pockels effect, which may be stronger than cross-phase modulation and may allow for control of the sign of the trapping phase. Using a THz trapping field may enable light to be confined to sub-picosecond pulses.

In some embodiments, confinement may be facilitated by cascaded χ⁽²⁾ interactions from an optical pulse. In such an embodiment, cascading χ⁽²⁾ interactions may produce an effective cross-phase modulation interaction. Moreover, cascaded χ⁽²⁾ interactions may provide control over the sign of the cross-phase modulation interaction, thereby allowing for bright-phase trapping in the normal-dispersion regime. Furthermore, cascaded χ⁽²⁾ interactions may enable independent tuning of the magnitude (and sign) of cross-phase modulation for both the pump filed and the signal field. This provides additional ability to adjust the trap if the pump field and signal GVD have opposite signs or differ by a large factor.

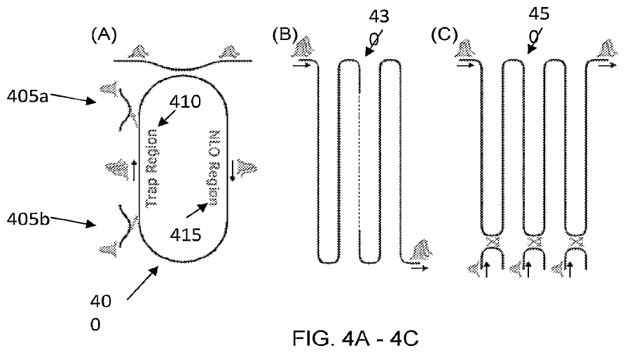

FIGS. 4A-C depict alternate structures for non-linear optical quantum computing system configured to confine an optical signal, according to some embodiments. As shown in FIG. 4A, the structure may include a ring, racetrack, or other ring-like cavity 400. In such embodiments, dedicated couplers 405a, 405b may be included for the trap wavelength, which is typically longer than the target wavelength, to prevent the trap field from resonating. In addition, the dedicated couplers may be used to divide the resonator into a trap region 410 and an NLO region 415.

As shown in FIG. 4B, the structure may include a single-pass waveguide 430. In such embodiments, the trap pulse may be a waveguide soliton that maintains its shape while simultaneously trapping the pump field and the signal field. In contrast to the ring structure 400, the waveguide structure 430 may require more area, but may increase throughput.

As shown in FIG. 4C, the structure may include a segmented single-pass waveguide 450. In such embodiments, the trap pulse may be periodically refreshed. A segmented single-pass waveguide 450 may be used for waveguides that do not support a trap soliton. In such a case, a trap pulse that may otherwise disperse or go off-phase relative to the pump field and the signal field when propagated down the waveguide may be replicated periodically.

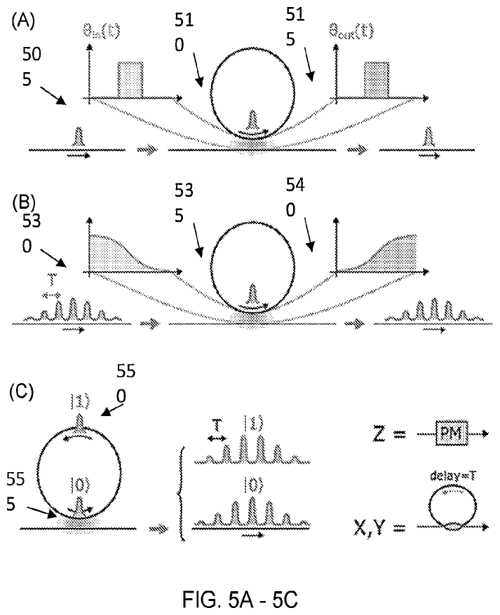

FIGS. 5A-C depict alternate methods of loading and unloading trapped pulses from an optical cavity, according to some embodiments. As shown in FIG. 5A, an optical trap pulse 505 may be instantaneously loaded 510 and unloaded 515 with a fast switch. In such embodiments, the fast switch couples the cavity mode to a single optical pulse. The switching hardware for the fast switch may operate at a rate that is fast compared to the time between pulses.

As shown in FIG. 5B, an optical trap pulse 530 may be gradually loaded 535 and unloaded 540 with a slow switch. In such embodiments, the slow switch couples the cavity mode to an optical pulse train. The switching hardware for the slow switch may be able to operate at a lower speed than for the fast switch described above. This may particularly be so in a time-multiplexed regime where the time between pulses is very short.

As shown in FIG. 5C, an optical trap pulse may be loaded and unloaded using either a fast switch or a slow switch in a manner that forms a grid-state temporal dual-rail qubit. In such embodiments, twofold time multiplexing may be used to store two pulses 550, 555 in a cavity. The two pulses 550, 555 may be used for dual-rail encoding. For fast loading/unloading, this may map to a standard time-bin dual-rail basis. For gradual loading/unloading, this may map to a grid-state temporal basis. In this instance, single-qubit gates may be approximated using phase modulators and delay loops, and the gate fidelity may increase exponentially with the number of lobes in the grid state.

In some embodiments, trapped modes may be multiplexed in a single ring cavity. In such embodiments, multiplexing may allow a single cavity to support a plurality of identical qubits. As such, multiplexing may simplify the hardware for an NLOQC system because only a single cavity may be stabilized. In contrast, in a non-multiplexed system, each qubit may be required to be stored in a separate cavity.

In some embodiments, time multiplexing may be used to generate and store multiple time offset pulses. In such embodiments, when the trap signal and the cavity are on an N:1 resonance, the cavity may store N independent pulses that are offset in time. This technique may also be performed in synchronously pumped optical parametric oscillator (OPO) coherent Ising machines.

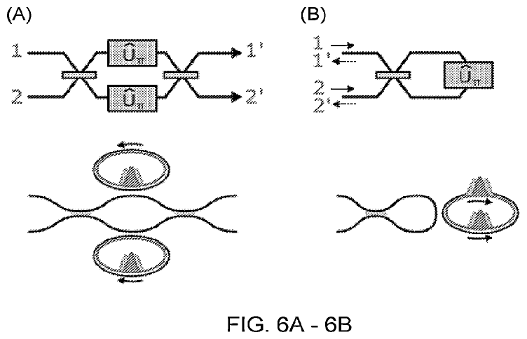

In some embodiments, directional multiplexing may be used to support different propagating directions. In such embodiments, ring cavities may support propagating modes. As such, data may be stored in both propagating directions within the ring. In this manner, directional multiplexing may be used to halve the number of rings required to implement a quantum gate, such as a CZ gate, as is shown in FIG. 6B, as compared to a non-multiplexed solution, as is shown in FIG. 6B.

In some embodiments, backscattering may be suppressed in a ring structure. Ring resonators having a high optical quality factor Q may incur mode splitting that arises from resonance-enhanced backscattering. Mode splitting reduces gate fidelity because a fraction of light is lost due to reflection out an incorrect port. In particular, backscattering may be significant because counterpropagating modes are degenerate due to reciprocity. However, the use of the trap field may remove the incidence of reciprocity and consequently can significantly suppress backscattering.

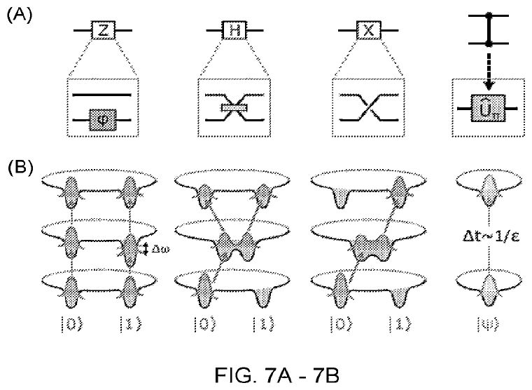

FIGS. 7A-7B illustrate quantum computing gates implemented with intracavity pulses and corresponding linear-optical transformations, according to some embodiments. As shown in FIGS. 7A-B, the systems and methods described herein may be used to implement gates on intracavity pulses using trap-potential engineering. As discussed further herein, with a dual-rail basis, single-qubit gates reduce to linear optics, while entangling gates require a Kerr-phase step, as shown in FIG. 7B. An intracavity dual-rail basis may also be realized using time multiplexing as set forth above.

FIG. 7B depicts linear-optical transformations (phase shifter, beamsplitter, waveguide crossing) that are implemented by adiabatically varying the potential to bring pulses together, thereby allowing the time bins to interact, while the Kerr-phase gate occurs automatically by holding the pulse in place and waiting for Δt˜1/ε, where e is the nonlinear coupling. One advantage of using this approach is that optical pulses are not required to enter or leave the cavity. Rather, each computation may be performed entirely using intracavity states, thereby eliminating losses and complexity resulting from loading and unloading.

In some embodiments, various aspects described above may be applied to quantum simulation. For example, temporal trap cavities with a plurality of closely spaced modes may be used to realize a one-dimensional bosonic lattice that is subject to mode hopping and a photon blockade in order to emulate the Bose-Hubbard model.

In some embodiments, temporal trapping may be used to realize an ensemble of identical OPOs with thresholds on the order of one photon by pumping the second harmonic. In such embodiments, the optical nonlinearity needed to realize a coherent Ising machine at the quantum (single-photon) limit may be enabled.

In some embodiments, a combination of nearest-neighbor coupling between closely spaced trap modes and a strong optical nonlinearity may facilitate the creation of large one-dimensional discrete-variable cluster states. In some such embodiments, two-dimensional or three-dimensional discrete-variable cluster states may also be created.

In some embodiments, quantum non-demolition (QND) detection may be used for quantum sensing and computing. Although Kerr-based QND detection is potentially possible with weak nonlinearities, the optical power required scales as P∝χ⁻². Because contemporary solid-state Kerr nonlinearities are weak, the optical power required is too great for practical purposes. Moreover, the cross-phase modulation signal is usually masked by self-phase modulation from the strong probe field. However, cascaded χ⁽²⁾ cross-phase modulation with a temporal trap may be used to resolve both of these issues with contemporary systems. As such, a strong (single-photon) and highly resonant cross-phase modulation effect may be realized without undesirable self-phase modulation.

In some embodiments, the purity of spontaneous parametric down-conversion (SPDC) single-photon sources may be improved by suppressing correlations in the joint-spectral density using temporal trapping. These correlations may be suppressed by favoring down-conversion to the bound state over other cavity states.

In some embodiments, the methods and systems described herein may be applied to pulse shaping in SHG, OPO, and other nonlinear processes. Pulse shaping may be performed with respect to any of a plurality of nonlinear optical light sources. Cross-phase modulation trapping may be used to substitute for synchronous pumping in pulsed OPOs, for example. Alternately, cross-phase modulation trapping may be used to provide an additional pulse-shaping degree of freedom.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A method for confining an optical signal in a non-linear optical quantum computing system, the method comprising:
generating an optical signal in the non-linear optical quantum computing system; and
generating a trap field that confines the optical signal by causing a nonlinear interaction, wherein the trap field propagates with the optical signal.

2. The method of claim 1, wherein the trap field comprises an optical pulse that imparts a time-dependent phase shift on a target field to create a temporal trap for the optical signal.

3. The method of claim 2, wherein the trap field comprises an electrical pulse.

4. The method of claim 1, wherein the trap field confines the optical signal in a time domain.

5. The method of claim 1, wherein the trap field confines the optical signal in space.

6. The method of claim 1, wherein the trap field confines the optical signal in space and in a time domain.

7. The method of claim 1, wherein the non-linear optical quantum computing system comprises a resonator having a ring cavity with one or more couplers, wherein the one or more couplers prevent the trap field from resonating within the resonator.

8. The method of claim 7, further comprising:
generating multiple optical signals in the non-linear optical quantum computing system;
confining the multiple optical signals with another trap field having a period that is a multiple of a cavity period; and
performing time multiplexing between the multiple trapped optical signals.

9. The method of claim 7, further comprising:
generating a second optical signal in the non-linear optical quantum computing system, wherein the second optical signal is transmitted in an opposite direction to the optical signal;
confining the second optical signal within the trap field; and
performing directional multiplexing between the optical signal and the second optical signal.

10. The method of claim 1, wherein the non-linear optical quantum computing system comprises a single-pass waveguide, wherein the trap field comprises a waveguide soliton.

11. The method of claim 1, wherein the non-linear optical quantum computing system comprises a segmented single-pass waveguide, wherein the trap field is periodically refreshed.

12. The method of claim 1, wherein the optical signal comprises a single target optical pulse.

13. The method of claim 1, wherein the optical signal comprises multiple optical pulses that are trapped in a single cavity.

14. A non-linear optical quantum computing system configured to:
generate an optical signal; and
generate a trap field that confines the optical signal by causing a nonlinear interaction, wherein the trap field propagates with the optical signal.

15. The non-linear quantum computing system of claim 14, wherein the trap field comprises an optical pulse that is configured to impart a time-dependent phase shift on a target field to create a temporal trap for the optical signal.

16. The non-linear quantum computing system of claim 14, wherein the trap field is configured to confine the optical signal in a time domain.

17. The non-linear quantum computing system of claim 14, wherein the trap field is configured to confine the optical signal in space.

18. The non-linear quantum computing system of claim 14, comprising a resonator having a ring cavity with one or more couplers configured to prevent the trap field from resonating within the resonator.

19. The non-linear quantum computing system of claim 18, further configured to:
generate a second optical signal;
confine the second optical signal within the trap field; and
perform time multiplexing between the optical signal and the second optical signal.

20. The non-linear quantum computing system of claim 18, further configured to:
generate a second optical signal that is transmitted in an opposite direction to the optical signal;
confine the second optical signal within the trap field; and
perform directional multiplexing between the optical signal and the second optical signal.
